(19) United States
(12) Patent Application Publication
(10) Pub. No.: US 2021/0283721 A1
(43) Pub. Date: Sep. 16, 2021

(54) LASER TREATMENT OF WRAPPING MATERIALS

(71) Applicant: SOREMARTEC S.A., FIndel (LU)

(72) Inventors: Sergio MANSUINO, Mondovì (Cuneo) (IT); Gabriele RATTO, Alba (Cuneo) (IT)

(73) Assignee: SOREMARTEC S.A., Findel (LU)

(21) Appl. No.: 16/338,897

(22) PCT Filed: Sep. 1, 2017
(86) PCT No.: PCT/IB2017/055267

§ 371 Date: Apr. 2, 2019

(30) Foreign Application Priority Data
Oct. 4, 2016 (LU) 93 248

(51) Int. Cl. B23K 26/402; B23K 26/08; B23K 26/382

(52) U.S. Cl. CPC B23K 26/402; B23K 2103/10; B23K 26/382; B23K 26/0846

(57) ABSTRACT

A sheet wrapping material including a metal layer (10), for example, aluminium, can be treated by applying a laser-treatment beam (LB1) to the metal layer (10). The metal layer (10) may be included in a multilayer set with a layer of polymeric material (50), by applying to the metal layer (10) coupled with the layer of polymeric material (50) a further laser-treatment beam (LB2), of a different wavelength, may be applied, to obtain also treatment of the polymeric material (50). The treatment may, for example, include cutting, pre-cutting, and perforation.

### TECHNICAL FIELD

The description relates to the treatment of sheet wrapping materials.

One or more embodiments may be applied to the treatment of sheet wrapping material including, for example, a layer of aluminium foil.

In the context of the present description, the term “treatment” is intended to include under a single term operations of processing of sheet wrapping material such as cutting, pre-cutting (i.e., a score made in the material or a partial removal of material, for example aluminium, designed to favour opening in a given area of the wrapping), perforation, etc.

### TECHNOLOGICAL BACKGROUND

For the treatment (e.g., cutting) of wrapping materials—in particular, sheet wrapping materials in the foodstuffs and confectionery sector—there is widespread use of mechanical means in various implementations.

The above implementations may require the use of even rather complex equipment, in particular when processing is carried out at very high rates (for example, of the order of thousands of units per minute) and/or on moving materials, for example on wrapping material that is being rolled off a reel for supplying a packaging and/or wrapping machine.

Moreover, the processing techniques prove intrinsically far from flexible: just to provide an example, when it is desired, for any reason, to modify the cutting path, to take into account a change of format or a change of shape of the wrapping, the mechanical processes entail in a practically inevitable way replacement of the corresponding tools.

To these considerations there may then be added considerations linked, for example, to the wear of the aforesaid tools, a phenomenon that can present even in quite short times in the case of packaging lines operating at high rates.

In numerous technical sectors, there have been asserted for some time now, as an alternative to implementations of a mechanical type, implementations that envisage the use of a laser beam.

Examples of such techniques are provided in documents such as U.S. Pat. No. 5,250,784 A (regarding cutting of thin films for electrochemical generators), U.S. Pat. No. 4,691,078 A (which describes a method for dividing and interrupting via laser cutting the conductive paths of an electrical aluminium circuit), or EP 1 736 272 A1 (which regards cutting of sanitary articles, for example sanitary towels, pads, and the like).

The latter document makes reference to the prior document EP 1 447 068 A1 as example of the possibility, offered by laser cutting, of modifying in a relatively simple and flexible way the cutting paths, even in the case where it is necessary to operate on moving products.

The question of cutting aluminium thin films is also treated in scientific papers such as “Laser Cutting of Aluminum Thin Film With No Damage to Under Layers”, Annals of the CIRP, Vol. 28/1, 1979.

Documents such as CN 102233482 A, CN 201669510 U, or CN 202622186U describe the possibility of using laser-cutting techniques on laminar aluminium materials, also with reference to the foodstuffs industry.

On the other hand, the latter documents cited make explicit reference to the need to subject the aluminium sheet, during cutting, to an operation of local cooling, implemented, for example, with a cooling-air source. The same documents likewise refer to the need to prevent melting of the metal material, which may give rise to cutting irregularities (burrs), that might even assume a conformation approximately resembling a sawtooth conformation, together with the drawbacks that can derive therefrom.

### OBJECT AND SUMMARY

The object of one or more embodiments is to overcome the drawbacks outlined above.

According to one or more embodiments, this object may be achieved thanks to a method having the characteristics recalled in the ensuing claims.

One or more embodiments may also regard a corresponding apparatus.

The claims form an integral part of the technical teachings provided herein in relation to the embodiments.

### BRIEF DESCRIPTION OF THE DRAWINGS

One or more embodiments will now be described, purely by way of non-limiting example, with reference to the annexed drawings, wherein:

FIG. 1 is a schematic representation of possible embodiments;

FIG. 2 is another schematic representation of possible embodiments;

FIG. 3 exemplifies a product that can be obtained according to one or more embodiments;

FIG. 4 exemplifies one or more embodiments;

FIG. 5 exemplifies a material that can be obtained with the apparatus of FIG. 4; and

FIG. 6, including two portions designated a) and b), respectively, exemplifies possible advantages that may derive from one or more embodiments.

It will be appreciated that, for clarity and simplicity of illustration, the various figures may not be represented at the same scale.

### DETAILED DESCRIPTION

In the ensuing description, various specific details are illustrated aimed at enabling an in-depth understanding of various examples of embodiments according to the description. The embodiments may be provided without one or more of the specific details, or with other methods, components, materials, etc. In other cases, known structures, materials, or operations are not illustrated or described in detail so that the various aspects of the embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment”, and the like, that may be present in various points of the present description do not necessarily refer exactly to one and the same embodiment. Moreover, particular conformations, structures, or characteristics may be combined in any adequate way in one or more embodiments.

The references used herein are provided merely for convenience and hence do not define the sphere of protection or the scope of the embodiments.

In the figures, the references L1 and L2 designate laser sources that can generate respective beams of laser radiation LB1, LB2, which may be used for carrying out operations of treatment on sheet wrapping material, for example for use in the foodstuffs or confectionery industry.

In the sequel of the present description, for reasons of simplicity reference will be made chiefly to the cutting operation, it remaining, however, understood that, as has already been said previously, one or more embodiments may be applied to operations of treatment of a different type such as cutting, pre-cutting, perforation, etc. of sheet wrapping material.

The possibility of using laser sources for treatment operations, such as cutting, is to be deemed in general known, for example from the various documents cited in the introductory part of the present description.

This applies in particular to the modalities that can be used for:
collimating and/or focusing/defocusing the laser beam onto the material that is being treated; and/or
imparting on the laser beam the desired paths, possibly operating on sheet materials that are moving, even at a rather high speed.

Likewise known is the possibility of associating, for these purposes, auxiliary devices, such as lenses, deflectors, collimators, etc. to the laser sources.

What has been said above renders superfluous any detailed description herein of the parts or elements represented in a deliberately simplified way in the annexed figures.

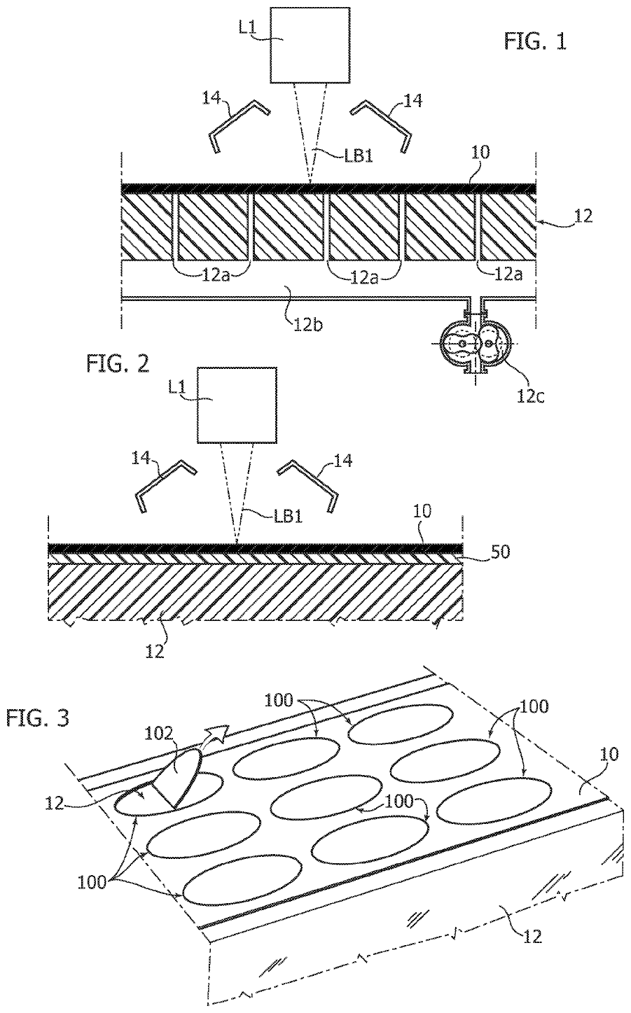

FIG. 1 exemplifies the possibility of using a laser source L1 for generating a laser beam LB1, which is able to make a score line on a sheet wrapping material 10. The material may also be printed, even with a number of colours. As exemplified in FIG. 1, the laser beam may thus impinge on a printed (here upper) surface of the material 10.

In one or more embodiments, the material 10 may include a layer of metal material such as aluminium.

In one or more embodiments, the layer 10 may have a thickness between 1 and 500 micron, possibly between 3 and 300 micron, and optionally between 5 and 50 micron (1 micron=10⁻⁶ m).

The choice of the material of the layer 10 is not, on the other hand, limited to aluminium.

Other possible choices of metal material may include, for example, steel (e.g., stainless steel) or brass.

In one or more embodiments, the laser L1 may be a fibre laser or a YAG laser.

In one or more embodiments, the laser L1 may have an emission wavelength in the range between 900 nm and 1500 nm (900-1500.10⁻⁹ m).

In various experiments, conducted by the present applicant, good results were obtained both with pulsed lasers, and with continuous emission (CW) lasers.

FIG. 1 exemplifies the fact that, in one or more embodiments, the operation of laser treatment of the layer 10 can be carried out with the metal layer 10 extending in surface contact with a substrate 12, i.e., causing the metal layer 10 to rest or adhere to the substrate 12 at least in the area where the laser beam LB1 is at that moment operating.

In one or more embodiments, the substrate 12 may include a material, such as polytetrafluoroethylene (Teflon). In particular, the fact that the metal layer 10 may rest on or adhere to the substrate 12 does not entail the need for permanent coupling.

For instance, FIG. 1 may refer to a working situation in which the metal layer 10 is made to slide—in a continuous way or by steps—on a substrate 12 such as a work-table, it thus being possible to get the layer 10 to remain stretched out, or in any case at a correct focal distance, within a given tolerance, where it is exposed to the action of the laser beam LB1.

FIG. 1 may likewise refer to a working situation in which the substrate 12 constitutes the top conveying branch of a motor-driven belt conveyor that feeds the layer 10 (also here continuously or by steps), thus enabling the layer 10 to remain stretched out, or in any case at a correct focal distance, within a given tolerance, where it is exposed to the action of the laser beam LB1.

In one or more embodiments, it is also conceivable that the substrate 12 is constituted by a transmission element, such as a roller, or ductor or drop roller, 12 capable of supporting the layer 10 at least locally so as to keep it stretched out, or in any case at a correct focal distance, within a given tolerance, where it is exposed to the action of the laser beam LB1, either independently or using an additional device.

In this regard, it is useful to consider the possibility of keeping the material 10 in position locally using a system such as a vacuum-positioning system, as represented schematically in FIG. 1, where, purely by way of example, there may be seen a substrate 12 traversed by ducts 12a communicating with a suction box 12b, where a sub-atmospheric pressure is present, produced by a vacuum pump 12c.

In one or more embodiments, the local positioning of the material 10 can be achieved with an electrostatic-attraction system.

In FIG. 1, the reference number 14 designates one or more suction devices, of a type in itself known, which can be provided for aspirating fumes that may develop as a result of the laser treatment.

It has been noted that a laser beam like the beam LB1 having characteristics of the type exemplified previously enables an action of treatment (e.g., cutting/perforation) of the layer of metal material 10, without having any appreciable effect on the material of the substrate 12.

In one or more embodiments, instead of being brought into contact with a substrate 12, the material 10 may be kept free in air, withheld stretched, e.g. at the sides.

FIG. 2 exemplifies possible embodiments in which the layer 10 is coupled with a layer of another material 50, such as a plastic material, e.g., a polymeric material, so as to form a multilayered set or assembly.

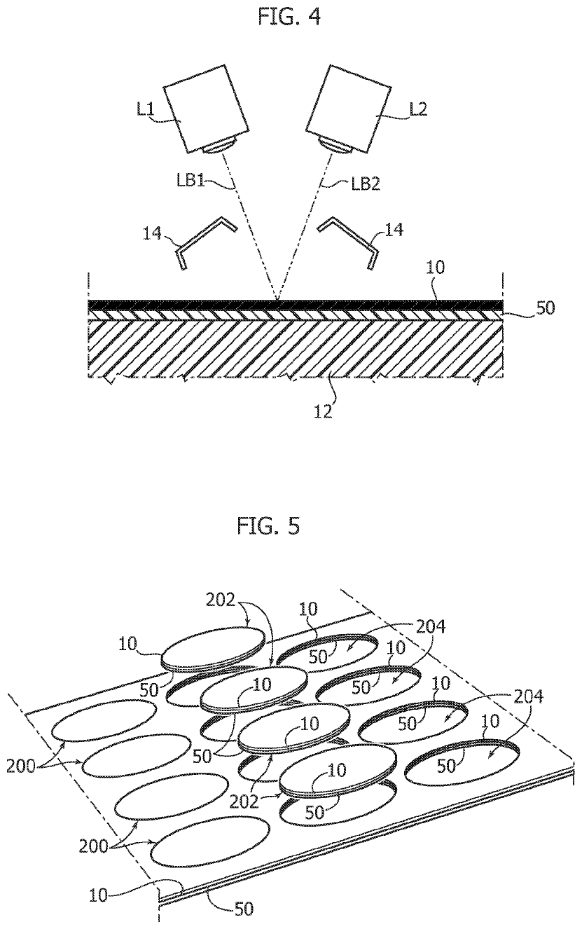

In one or more embodiments, the substrate 12 (if present) may present in any of the forms mentioned previously with reference to FIG. 1. In FIG. 2 and in FIG. 4 (where parts and elements already described in relation to FIG. 1 are designated by the same references that appear in FIG. 1) the substrate 12 is represented in a deliberately simplified way so that other aspects of the embodiments will not be obscured.

In this connection, it is once again recalled that, in one or more embodiments, instead of being brought into contact with a substrate 12, the material 10 (here with the material 50) can be kept free in air, withheld stretched (e.g. at the sides).

For instance, in one or more embodiments, the layer of material 50 represented in FIG. 2 may have a thickness between 1 and 500 micron, optionally between 3 and 300 micron, and in a further option between 5 and 50 micron (1 micron=10⁻⁶ m).

In one or more embodiments, the set of layers 10 and 50 (plus other possible layers, not illustrated in the figures) may correspond to a wrapping material of the type currently referred to as “multilayer”, in English terminology.

In one or more embodiments, the set of layers 10 and 50 (plus other possible layers, not illustrated in the figures) may correspond to using a metallised plastic material (e.g. polypropylene PP), with a metallization which may lie between 10 and 500 \acute{Å}ngstrom (1 \acute{Å}ngstrom=10⁻¹⁰ m).

Whatever the solution adopted for providing such a set or assembly of layers, the material 50 may include a material chosen, even in possible combinations, from polypropylene (PP), polyethylene (PE), polyester, polyamide (nylon), polystyrene or other polymer materials, such as e.g. polymers from biomasses (e.g. based on corn, rice, and so on) and/or bio-degradable materials such as so-called “compostable” materials, which may be coupled with metal materials (such as e.g. aluminium) and may be suited for being metallised.

It has been noted that a laser beam, such as the beam LB1 having characteristics of the type exemplified previously, enables an action of treatment (e.g., cutting/perforation) of the layer of metal material 10, without having any appreciable effect either on the material of the substrate 12 or on the material 50.

Without on the other hand wishing to be tied down to any specific theory in this regard, there is reason to think that the solutions exemplified in the figures enable control of the dissipation of the heat developed at a local level by the laser beam, causing, for example, cutting/perforation of the layer 10 to take place mainly following upon a phenomenon of sublimation, with direct passage from the solid state to the aeriform state, without having any appreciable passage to the liquid state. In this way, a cut or perforation with clean edges, i.e., substantially without any burrs, is facilitated.

FIG. 3 exemplifies a possible result of an action of cutting of the layer of metal material 10 carried out with the modalities exemplified previously, i.e., without any appreciable effects on the material of the substrate 12.

In this way, it is possible to create a treated web, where formed in the metal layer 10 are cutting paths 100 having, for example, an oval or elliptical shape, this of course being a choice purely provided by way of example in so far as the path may be any, precisely thanks to the extreme flexibility afforded by laser cutting.

Added to this is also the possibility of “peeling” (as exemplified on the left in FIG. 3) portions 102 of metal sheet wrapping material that are identified by the cutting lines 100, which can then be sent on to subsequent handling operations (for example, wrapping of foodstuffs and/or confectionery products).

The illustration (which is deliberately schematic) of FIG. 3 provides an example of the general possibility of separating the portions 102 from the layer 10 as a whole, irrespective of the specific modalities of implementation of this operation in the context of an industrial packaging plant.

Of course, in one or more embodiments it is possible to use the material 102 and discard the remaining material.

It will likewise be appreciated that, as exemplified in FIG. 6, it is possible to define the cutting paths 100 in such a way as to minimise the production of scrap material, i.e., the portion of material 10 that remains after the operation of cutting and removal of the portions 102.

In one or more embodiments, for example when recourse is had to the solution exemplified in FIG. 2 (multilayered set 10 and 50), it may be desirable to be able to carry out an action of treatment (e.g., cutting/perforation) that may involve not only the layer 10 but also the layer 50.

In one or more embodiments, such a result can be achieved by resorting to the solution exemplified in FIG. 4, where there may be combined to the laser L1 (for example, of the type exemplified previously) a second laser source L2, which is able to generate a laser beam LB2, capable of performing an operation of treatment (e.g., cutting/perforation) on the material (e.g., polymeric material) 50.

The foregoing, in one or more embodiments, may be obtained as follows:
the beam LB1 acts on the layer 10 (without having any appreciable effects on the layer 50); and
the beam LB2 acts on the layer 50 (without having any appreciable effects on the layer 10).

In one or more embodiments, it is possible to obtain the layer 10 so that it is practically transparent to the radiation of the source L2, with the layer 50 practically transparent to the radiation of the source L1.

In one or more embodiments, the two laser sources L1, L2 (operating according to criteria in themselves known) may be configured in such a way that the respective beams LB1, LB2 act simultaneously, practically simultaneously or in an alternated manner on the two layers, i.e., with the beam LB1 that acts on the layer 10 while the beam LB2 is acting on the layer 50.

For instance, in one or more embodiments (in the case where it is not desired to resort to multiple laser sources, which can emit at different wavelengths, or to deflector mirrors) it is possible to arrange the two laser sources L1, L2 in such a way the respective beams LB1, LB2 hit at corresponding or at least substantially corresponding locations with:
the radiation of the laser beam LB1 of the source L1 propagating towards the metal layer 10, so as to carry out the treatment operation (e.g., cutting/perforation) described previously;
the radiation of the laser beam LB2 of the source L2 propagating towards the polymeric layer 50, also here so as to carry out the treatment operation (e.g., cutting/perforation) described previously.

In one or more embodiments, the laser source L2 may be a CO₂ laser source.

In one or more embodiments, the laser L2 may have an emission wavelength in the range between 9 and 11 micron (9-11.10⁻⁶ m), for example, at around 9.6 micron or 10.6 micron (9.6 or 10.6.10⁻⁶ m).

In this connection, it may be noted that a CO₂ laser having characteristics as exemplified previously is indicated for polymeric materials, whereas a fibre laser is suited also for metal materials as well as for some polymeric materials.

It is once again recalled that the representation of the sources L1 and L2 provided in the annexed figures is deliberately simplified.

In particular, not visible in FIGS. 1, 2, and 4 are possible deflection units (of a type in itself known) that enable the two laser beams LB1 and LB2 to be oriented towards the layers 10 and 50 according to paths that substantially coincide. All this enables the two layers 10, 50 to be handled in a practically simultaneous way.

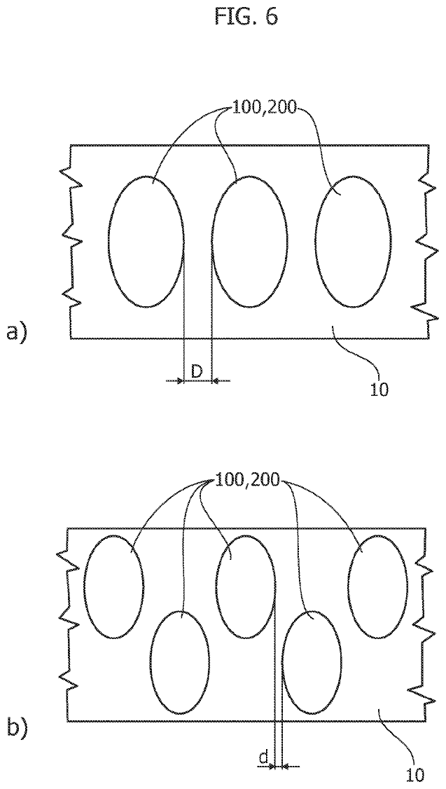

FIG. 5 exemplifies a possible result of the operation of treatment of a multilayer material 10, 50, for example of a type as discussed previously, subjected to a cutting operation according to the modalities exemplified in FIG. 4.

In particular, by operating with the two sources L1, L2 it is possible to form, in the multilayer material 10, 50 cutting paths 200 that involve both of the layers 10 and 50.

In this way, the formations 202 deriving from the cutting operation (once again here reference is made, purely by way of non-limiting example, to formations of an elliptical or oval shape) may be separated in the form of elements of multilayer material, which can then be sent on to subsequent handling operations (for example, wrapping of foodstuffs and/or confectionery products).

Holes 204 remain in the multilayer material 10, 50 once it has been treated and once the formations 202 have been removed.

Of course, in one or more embodiments it is possible to use the material 202 and discard the remaining material.

As in the case of the representation of FIG. 3, in one or more embodiments, as exemplified in FIG. 5, it is possible to define cutting paths 200 in such a way as to minimise the production of scrap material, i.e., the portion of multilayer material 10, 50 that remains after the operation of cutting and removal of the formations 202.

In that respect, FIG. 6 exemplifies, with possible reference both to FIG. 3 (cutting trajectories 100) and to FIG. 5 (cutting trajectories 200), the possibility, provided by one or more embodiments, to reduce the separation distances between the cutting trajectories from the values generally indicated as D in part a) of the figure, which are representative of mechanical cutting (and take into account the dimensions of the cutting tools or “knives”), to the values generally indicated as d in part b) of the figure, which are notably smaller, with an ensuing reduction of scrap.

Without prejudice to the underlying principles, the details of construction and the embodiments may vary, even significantly, with respect to what has been illustrated herein purely by way of non-limiting example, without thereby departing from the extent of protection.

The extent of protection is defined by the annexed claims.

1. A method for the treatment of sheet wrapping material including a metal layer (10), the method including applying a laser-treatment beam (LB1) to said metal layer (10).

2. The method according to claim 1, including applying said laser-treatment beam (LB1) to said metal layer (10) with:
said metal layer (10) in surface contact with a supporting material (12), preferably withheld by vacuum pressure (12a, 12b) or by electrostatic attraction,
or else
said metal layer (10) free and withheld stretched.

3. The method according to claim 1, wherein said metal layer (10) includes aluminium.

4. The method according to claim 1, wherein said metal layer (10) has a thickness between 1 and 500 micron, preferably between 3 and 300 micron, and even more preferably between 5 and 50 micron (1 micron=10⁻⁶ m).

5. The method according to claim 1, wherein said laser-treatment beam (LB1) has an emission wavelength in the range between 900 nm and 1500 nm (900-1500.10⁻⁹ m).

6. The method according to claim 1, including generating said laser-treatment beam (LB1) via a fibre laser or a YAG laser.

7. The method according to claim 1, including providing said metal layer (10) in a multilayer set with a layer of polymeric material (50).

8. The method according to claim 7, wherein said multilayer set (10, 50) includes metallised polymer material, preferably with a metallisation thickness between 10 and 500 \acute{Å}ngstrom (1 \acute{Å}ngstrom=10⁻¹⁰ m).

9. The method according to claim 7, wherein said layer of polymeric material (50) has a thickness between 1 and 500 micron, preferably between 3 and 300 micron, and still preferably between 5 and 50 micron (1 micron=10⁻⁶ m).

10. The method according to claim 7, wherein said polymeric material (50) includes material chosen from polypropylene (PP), polyethylene (PE), polyester, polyamide (nylon), polystyrene, polymers from biomasses, bio-degradable polymers, compostable polymers or combinations thereof.

11. The method according to claim 7, including applying to said multilayer set (10, 50) a further laser-treatment beam (LB2) for treating said polymeric material (50).

12. The method according to claim 11, wherein said laser-treatment beam (LB1) and said further laser-treatment beam (LB2) are of different wavelengths.

13. The method according to claims 11, wherein said further laser-treatment beam (LB2) has an emission wavelength in the range between 9 and 11 micron (9-11.10⁻⁶ m), preferably at around 9.6 micron or 10.6 micron (9.6 or 10.6.10⁻⁶ m).

14. The method according to claim 11, including generating said further laser-treatment beam (LB2) using a CO₂ laser.

15. The method according to claim 1, wherein said treatment is chosen from among cutting, pre-cutting, and perforation.

16. An apparatus for laser treatment of sheet wrapping material for implementation of the method according to claim 1, the apparatus including:
a source of said laser-treatment beam (LB1); and
means for supporting said metal layer (10) during application of said laser-treatment beam (LB1).

17. The apparatus according to claim 16, wherein said supporting means are chosen between:
supporting material (12), which is able to co-operate in surface contact with said metal layer (10), preferably withheld by vacuum pressure (12a, 12b) or by electrostatic attraction on said supporting material (12); and
a means for supporting said metal layer (10) in such a way that is free and withheld stretched.

18. The apparatus according to claim 16, the apparatus further including a source (L2) of said further laser-treatment beam (LB2).
